(19) United States
(12) Patent Application Publication
(10) Pub. No.: US 2026/0061938 A1
(43) Pub. Date: Mar. 5, 2026

(54) VEHICLE WITH MOVABLE STORAGE CONTAINER

(71) Applicant: FCA US LLC, Auburn Hills, MI (US)

(72) Inventors: Mark E Stout, Auburn Hills, MI (US); Stacey L Berger, Auburn Hills, MI (US); Santiago Caceres, Auburn Hills, MI (US); Brandon F Brady, Auburn Hills, MI (US); Travis D Bechtel, Auburn Hills, MI (US)

(21) Appl. No.: 18/819,414

(22) Filed: Aug. 29, 2024

(51) Int. Cl. B60R 7/04

(52) U.S. Cl. CPC B60R 7/04

(57) ABSTRACT

A vehicle includes a vehicle body having a front compartment, a passenger compartment and a divider between the front compartment and the passenger compartment. The divider having an opening through which the front compartment and the passenger compartment are communicated. A path is provided through the opening and extending to the front compartment and partly in the passenger compartment, and a container is movable along the path between a first position in which the container is within the front compartment and a second position in which the container is received within the passenger compartment.

### FIELD

The present disclosure relates to a vehicle with a movable storage container.

### BACKGROUND

Items left within a vehicle passenger compartment when the vehicle is not in use, or is used by a person other than the owner, for example a valet, are at risk of being stolen. Further, items stored within a cargo compartment of the vehicle that it outside of the passenger compartment are not accessible to a driver and storage space within the passenger compartment is limited.

### SUMMARY

In at least some implementations, a vehicle includes a vehicle body having a front compartment, a passenger compartment and a divider between the front compartment and the passenger compartment. The divider having an opening through which the front compartment and the passenger compartment are communicated. A path extends through the opening and at least partly into the passenger compartment, and a container is movable along the path between a first position in which the container is within the front compartment and a second position in which the container is received within the passenger compartment.

In at least some implementations, a motor and a drive member driven by the motor and coupled to the container so that the motor causes movement of the container along a track in the path. In at least some implementations, the drive member includes a belt, screw (rotatably or stationary), chain or cable that extends along at least part of a length of the track, and the drive member is coupled to the container. In at least some implementations, the drive member is a rotating component that engages the track and moves along the track as the rotating component is rotated by the motor. In at least some implementations, the rotating component is at least one gear or at least one wheel.

In at least some implementations, a console is located in the passenger compartment and includes a void that is open toward the divider, wherein, when the container is in the second position, at least a portion of the container is received within the void. In at least some implementations, the console includes a console opening that is communicated with the void so that the container is accessible through the console opening.

In at least some implementations, the divider includes a cover that is movable relative to the opening between a first position in which the cover permits the container to pass through the opening, and a second position in which the cover prevents the container from passing through the opening.

In at least some implementations, a first portion of the track extends through the opening and the track includes a second portion that is received within the front compartment and which includes extends at a non-parallel angle to the first portion, and wherein the container is movable along the second portion to a position in which the container is not aligned with the first portion.

In at least some implementations, the container is a first container and wherein a second container is provided, the first container and the second container are both movable along the second portion and separately registrable with and movable along the first portion.

In at least some implementations, the first portion extends in a fore-aft direction which extends between a front end and a rear end of the vehicle and the second portion extends in a cross-car direction which extends between a left side and a right side of the vehicle.

In at least some implementations, an instrument panel defines or is coupled to the divider, and opening is located below the instrument panel. In at least some implementations, the opening extends through part of the instrument panel.

In at least some implementations, a vehicle includes a vehicle body, a container path, a container, an actuator and a console. The vehicle body has a front compartment, a passenger compartment and a divider between the front compartment and the passenger compartment, and the divider has an opening through which the front compartment and the passenger compartment are communicated. The container path is located partly in the front compartment and partly in the passenger compartment, and extends through the opening. The container is movable along the path between a first position in which the container is within the front compartment and a second position in which the container is received within the passenger compartment. The actuator is coupled to the container and is operable to move the container along the path. And the console is located in the passenger compartment and includes a void that is open toward the divider. When the container is in the second position, at least a portion of the container is received within the void.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a perspective view of a vehicle;

FIG. 2 is an overhead view of part of the vehicle showing one or more storage containers in a cargo compartment;

FIG. 3 is a side view of part of the vehicle as in FIG. 2;

FIG. 4 is an overhead view of part of the vehicle showing one or more storage containers in a passenger compartment; and

FIG. 5 is a side view of part of the vehicle as in FIG. 4.

### DETAILED DESCRIPTION

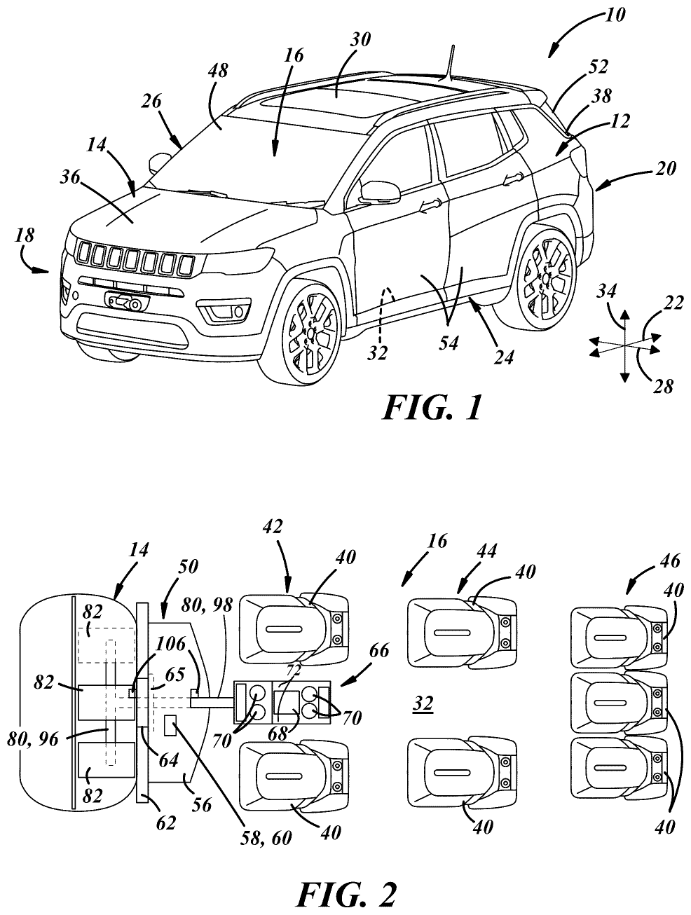

Referring in more detail to the drawings, FIG. 1 shows a vehicle 10 that includes a vehicle body 12 having a cargo compartment 14 and a passenger compartment 16. The vehicle 10 includes a front end 18 and a rear end 20 that are spaced apart in a fore-aft direction (shown by arrow 22), left and right sides 24, 26 that are spaced apart in a cross-car direction (shown by arrow 28), and a roof 30 and floor 32 that are spaced apart in a vertical direction (shown by arrow 34). The cargo compartment 14 may be separate from the passenger compartment 16 and typically is provided at one or both of the rear of the vehicle 10 (often called a trunk) and the front of the vehicle 10 (often called a front compartment 14 or frunk). A vehicle deck lid, such as a hood 36 or trunk lid 38 may define part of the cargo compartment 14, in at least some implementations. The deck lid is movable from a closed position to an open position to permit access to the area beneath the deck lid, which may include the cargo compartment 14. While not limited to electric vehicles, certain electric vehicles have considerable space available in the front compartment 14 or frunk and may be readily adapted for storage as noted herein.

Referring to FIGS. 2-5, the passenger compartment 16 is part or all of a vehicle interior and includes seats 40 for vehicle 10 occupants. In the example shown, a front row 42 of seats 40 includes two seats, e.g. for a driver and front passenger, a second row 44 with two seats 40 spaced apart in the cross-car direction, and a third row 46 having three seats 40. Any desired seating configuration may be used. The passenger compartment 16 may be defined at least in part by the roof 30 (e.g. interior headliner), floor 32, a windshield 48 (FIG. 1) and an instrument panel 50 at a front of the passenger compartment 16, a rear window 52 (FIG. 1) and/or body panel at a rear of the passenger compartment 16, and one or more doors 54 (FIG. 1) at the left and right sides 24, 26 of the vehicle 10, and associated vehicle structural components, such as pillars that extend to and are coupled to the roof.

The instrument panel 50 includes one or more interior trim pieces 56 and one or more displays 58 on which vehicle operational information is provided (e.g. gauges for speed, engine temperature and engine rpms, and icons for warning messages, etc.) and via which a human-machine interface (HMI) 60 may be provided. The HMI 60 may be part of an infotainment system by which various vehicle controls may be implemented or selected by a user, such as by a touch screen or other inputs like buttons or dials, and by which a remote device may be connected (e.g. a smart phone) and audio (e.g. radio/sound system) and other devices or systems may be accessed for user control. On or near the instrument panel 50, one or more drive controls may be provided, such as a steering input/wheel, a transmission/powertrain gear selector, an accelerator input and a brake input. The instrument panel 50 may define or be connected to a divider 62 that spans in the cross-car direction between the left and right sides 24, 26, in the vertical direction from the floor 32 to the windshield 48, and is located in the fore-aft direction between the cargo compartment 14 and the passenger compartment 16. The divider 62 may be, in at least some implementations, a structural member of the vehicle 10, sometimes called a firewall and may be used to separate powertrain components in the front compartment 14 from the passenger compartment 16 and to mount or passthrough various vehicle 10 components within the front compartment 14. The divider 62 may define at least part of the passenger compartment 16, in at least some implementations.

To permit at least selective communication between the cargo compartment 14 and the passenger compartment 16, an opening 64 is provided in the divider 62. The opening 64 may be located below the instrument panel 50 or through part of the instrument panel 50. In at least some implementations, a cover 65 is provided that is movable relative to the opening 64 to selectively close and open the opening 64.

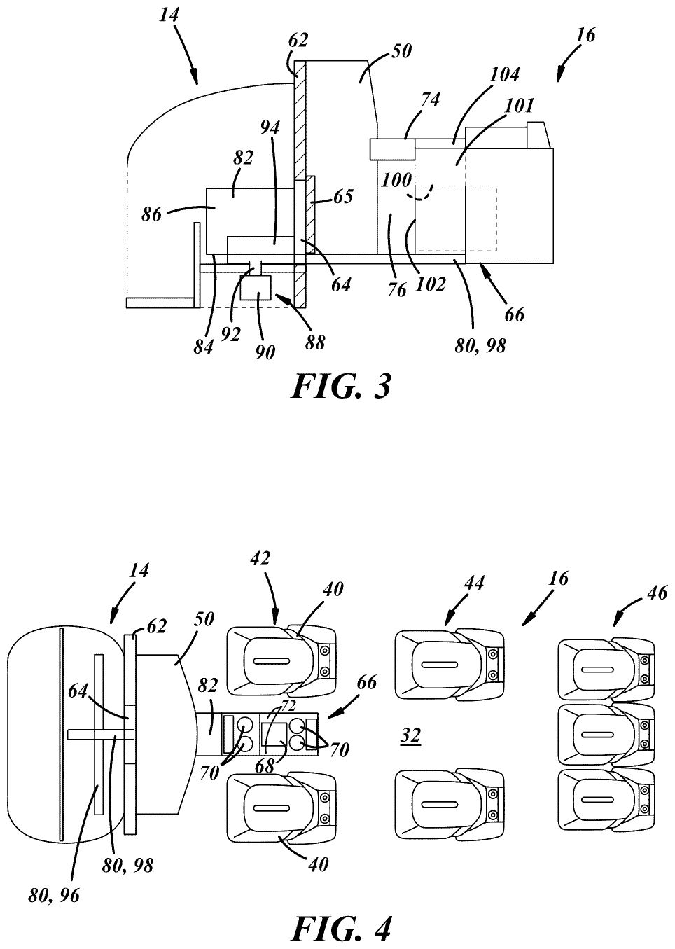

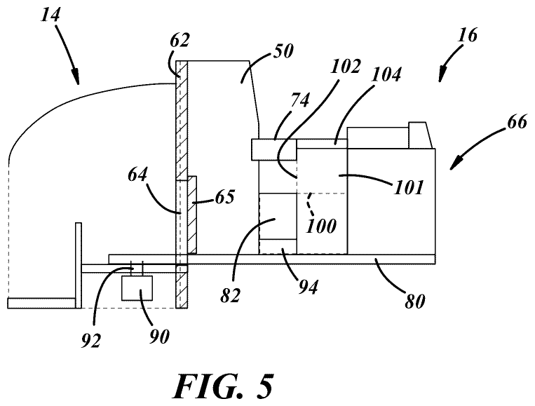

The vehicle 10 may include a console 66 that may, for example, have one or more storage compartments 68, one or more cupholders 70, an armrest 72 and other features or components as desired. The console 66 may be located between two seats 40, such as between the front two seats, as shown in FIGS. 2-5. In this arrangement, the console 66 may be generally centered in the cross-car direction and may be spaced from the instrument panel 50 in the fore-aft direction. The console 66 could be part of the instrument panel 50, or it may be coupled thereto by a bridge 74, such as is shown in FIGS. 3 and 5. The bridge 74 may provide some of the features noted (e.g. cupholders or storage areas) and may be spaced vertically from the floor 40 and arranged near an upper portion of the console 66. A space 76 (FIG. 3) may be provided between a lower surface of the bridge 74 and the floor 40, and things may be stowed in the space. Sidewalls or the like may be provided to contain items and keep the items out of footwells in front of the seats 40.

To contain stowed items and to facilitate moving items between the cargo compartment 14 and the passenger compartment 16, the vehicle 10 may include a container path 79 that extends through the opening and between the cargo compartment 14 and at least partly into the passenger compartment 14. A track 80 may be provided along at least part of the path 79, and the track may extend through the opening 64 and have part located in the cargo compartment 14 and/or part in the passenger compartment 16. The track 80 may be of any suitable construction and may be continuous or discontinuous along its length which may be oriented in the fore-aft direction. The track 80 may extend into the passenger compartment 16 and to, partly into or adjacent to the console 66. While shown as an elongated and generally flat member received on the floor of the vehicle 10, the track 80 may instead or in addition include sidewalls or guiderails spaced apart in the cross-car direction, such as a channel or the like.

To facilitate transferring things between the cargo compartment 14 and the passenger compartment 16, a container 82 is associated with the track 80 and is movable along the track 80. As shown in FIG. 3, the container 82 has a body which may include a bottom wall 84 and sidewalls 86 extending vertically from the bottom wall 84. The container 82 may be open at its upper end or closed, such as by a removable or movable cover or lid. Items may be placed in and contained by the container 82, and removed thereform, as desired. As shown in FIGS. 2 and 3, the container 82 has a first position in which the container 82 is located within the cargo compartment 14 and, as shown in FIGS. 4 and 5, a second position in which the container 82 is located within the passenger compartment 16. The container 82 may be of any suitable size and shape and is designed to pass through the opening 64 when it moves between the first and second positions, and the container 82 may be stopped between those positions in one or more intermediate positions, as desired.

The container 82 may be manually moved along the track 80 or the container 82 may be coupled to and driven by an actuator 88. In at least some implementations, the actuator 88 includes a motor 90 and a drive member 92 that is driven by the motor. For example, the motor 90 may be fixed in the vehicle 10, such as in the cargo compartment 14 or otherwise in the front compartment 14, and the motor 90 the drive member 92 may be a power transmission member, such as a belt, chain, cable or a screw which may be rotatable or stationary. The belt, chain, cable or screw (by way of non-limiting examples) may be driven by a gear or wheel that is rotated by the motor 90, or otherwise driven, as desired. To move the container 82, the container 82 may be coupled to the drive member 92 for movement as the drive member 92 moves. In at least some implementations, as shown in FIGS. 3 and 5, a shuttle or carrier 94 is provided that is coupled to the drive member 92, and the container 82 is connected to the carrier 94 so that both the carrier 94 and container 82 are driven by the motor 90. Other arrangements may be used, as desired. For example, the motor 90 may be carried by the container 82 and may directly rotate wheels coupled to the container 82 to move the container 82 relative to the vehicle 10. The wheels may move along the vehicle floor, or along the track 80, or both.

In at least some implementations, the container 82 may be movable within the cargo compartment 14 such that the container 82 has positions in which the container 82 is not aligned with the opening 64. That is, the container 82 may be offset in the cross-car direction, for example, from the opening 64. To facilitate such movement, as shown in FIGS. 2 and 4, the track 80 may include a second portion 96 that is received in the cargo compartment 14 and which guides and enables movement of the container 82 in the cross-car direction. In the example shown, the second portion 96 is provided at an end of the first portion 98, which extends into the passenger compartment 16. This lateral or cross-car movement of the container 82 can help to move the container 82 out of the center of the cargo compartment 14.

Additionally, the movement in a second direction enables more than one container 82 to be received in the cargo compartment 14, and selectively aligned with and movable through the opening 64, as shown in FIG. 2. In this way, a first container 82 may be moved in the cross-car direction out of the way of the opening 64 and spaced from the end of the first portion 98 of the track 80, to permit a second container 82 to be aligned with the opening 64 and ready for movement along the first portion 98 of the track 80 (e.g. into the passenger compartment 16). The second portion 96 of the track 80 may accommodate movement of a container 82 in one or both directions away from the opening 64 (e.g. toward the right and/or left sides of the vehicle 10). A separate actuator may be provided to move the containers 82 in the cross-car direction. The containers 82 may be moved along the second portion 96 on a carrier or shuttle 94, which may be arranged for movement along both the second portion 96 and the first portion 98 of the track 80, in a least some implementations. In this way, each container 82 may be received on a separate carrier or shuttle 94. The containers 82 may be releasable from the carriers or shuttles 94 and track 80 to permit the containers 82 to be removed from the vehicle 10, if desired.

In some implementations, the front compartment may have a floor that is lower than the level of the opening and a lifting mechanism may be used to raise the container(s) 82 from the level of the front compartment floor to the level of the opening. Non-limiting examples of lifting mechanisms include a scissor lift, screw mechanism, and the like. Mechanisms other than a motor and a track may be used to move the container(s) 82 within the front compartment, as desired.

To facilitate loading the containers 82 from within the passenger compartment 16 or retrieving items from the containers 82 from within the passenger compartment 16, in at least some implementations, the container 82 meshes or cooperates with the console 66. In the embodiment shown, and with reference to FIGS. 3 and 5, the console 66 includes a void 100 in a forward most or forward-facing side 102 of the console 66. When the container 82 is in the second position, the container 82 is received at least partially in the void 100. The container 82 may define part or all of a storage compartment of the console 66, and it may be accessed by opening a lid or cover 104 on the console 66 that overlies a console opening 101 or chamber leading to the void 100.

In at least some embodiments, the container 82 may be moved to the second position while the vehicle 10 is in use, to permit items to be stored in and retrieved from the console 66. This may occur automatically, if desired, when the vehicle 10 is turned on or otherwise set for use. Additionally, when the vehicle 10 is turned off or otherwise set for non-use, the container 82 may be moved into the cargo compartment 14 so that the container 82 and the contents therein are not accessible from within the passenger compartment 16. This may also be done automatically, if desired. Or this may be done as commanded by a user (e.g. via the HMI). This may be desirable to deter thieves from breaking into the passenger compartment 16 in search of items left in the passenger compartment 16.

In this regard, the cover 65 for the opening 64 may be closed other than when the container 82 is moving therethrough. The cover 65 may be opened manually, or automatically by an actuator. Proximity switches or sensors 106 (FIG. 2), for example, may be used to control movement of the cover 65 to permit a container 82 to pass through the opening 64 and to close the opening 64 after a container 82 moves through the opening 64. The cover 65 could be mechanically driven by movement of the container 82 relative thereto, if desired. By way of a non-limiting example, the container 82 may as it moves near the cover 65 displace a lever or cam that causes movement of the cover 65, and the system may be spring loaded to return to a starting position after such movement. Of course, other arrangements may be used, as desired, including arrangements with or without a cover and in which the container 82 blocks all or part of the opening. For example, when a container 82 is received within the front compartment, a surface of the container may be within the opening and block access to the interior of the container from within the passenger compartment. A cover or other component to block the opening may desirable for security reasons as well as for noise and environment isolation from the passenger compartment 16.

Further, the cargo compartment 14 may be fully enclosed or lockable such that opening the deck lid does not provide direct access to the cargo compartment 14 and containers 82. In this way, items may be stored securely when the vehicle 10 is not in use, or if the vehicle 10 is to be used by another person, for example without limitation, a valet who may drive the car to park it. Prior to giving the vehicle 10 to the valet (or other person), the container 82 may be moved into the cargo compartment 14. Further, the system can be set up to prevent others from commanding the container(s) 82 to move out of the cargo compartment 14, for example, by a lock/key or password/secure identification (e.g. fingerprint reader) type arrangement.

The systems provide a unique storage solution that enables easy transfer of things between a passenger compartment and a storage compartment. This may facilitate having more things accessible within the vehicle, such as with multiple containers that may be selectively brought into the passenger compartment. Increased security is also achievable by enabling stored items to be removed from the passenger compartment and located in a secure area outside of the passenger compartment when not needed, or when the vehicle is parked or might be driven by another person.

What is claimed is:

1. A vehicle, comprising:
a vehicle body having a front compartment, a passenger compartment and a divider between the front compartment and the passenger compartment, the divider having an opening through which the front compartment and the passenger compartment are communicated;
a path extending through the opening and into the passenger compartment; and
a container movable along the path between a first position in which the container is within the front compartment and a second position in which the container is received within the passenger compartment.

2. The vehicle of claim 1 which also includes a track extending along at least part of the path, and which also includes a motor and a drive member driven by the motor and coupled to the container so that the motor causes movement of the container along the track.

3. The vehicle of claim 2 wherein the drive member includes a belt, screw, chain or cable that extends along at least part of a length of the track, and the drive member is coupled to the container.

4. The vehicle of claim 2 wherein the drive member is a rotating component that engages the track and moves along the track as the rotating component is rotated by the motor.

5. The vehicle of claim 4 wherein the rotating component is at least one gear or at least one wheel.

6. The vehicle of claim 1 which also includes a console located in the passenger compartment and including a void that is open toward the divider, wherein, when the container is in the second position, at least a portion of the container is received within the void.

7. The vehicle of claim 6 wherein the console includes a console opening that is communicated with the void so that the container is accessible through the console opening.

8. The vehicle of claim 1 wherein the divider includes a cover that is movable relative to the opening between a first position in which the cover permits the container to pass through the opening, and a second position in which the cover prevents the container from passing through the opening.

9. The vehicle of claim 1 which also includes a track extending along at least part of the path, and wherein a first portion of the track extends through the opening and the track includes a second portion that is received within the front compartment and which includes extends at a non-parallel angle to the first portion, and wherein the container is movable along the second portion to a position in which the container is not aligned with the first portion.

10. The vehicle of claim 9 wherein the container is a first container and wherein a second container is provided, the first container and the second container are both movable along the second portion and separately registrable with and movable along the first portion.

11. The vehicle of claim 9 wherein the first portion extends in a fore-aft direction which extends between a front end and a rear end of the vehicle and the second portion extends in a cross-car direction which extends between a left side and a right side of the vehicle.

12. The vehicle 1 which also includes an instrument panel that defines or is coupled to the divider, and wherein the opening is located below the instrument panel.

13. The vehicle of claim 1 which also includes an instrument panel that defines or is coupled to the divider, and wherein the opening extends through part of the instrument panel.

14. A vehicle, comprising:
a vehicle body having a front compartment, a passenger compartment and a divider between the front compartment and the passenger compartment, the divider having an opening through which the front compartment and the passenger compartment are communicated;
a path extending through the opening and at least partly into the passenger compartment;
a container movable along the path between a first position in which the container is within the front compartment and a second position in which the container is received within the passenger compartment;
an actuator coupled to the container and operable to move the container along the path; and
a console located in the passenger compartment and including a void that is open toward the divider, wherein, when the container is in the second position, at least a portion of the container is received within the void.

15. The vehicle of claim 14 wherein the console includes a console opening that is communicated with the void so that the container is accessible through the console opening.

16. The vehicle of claim 14 wherein the divider includes a cover that is movable relative to the opening between a first position in which the cover permits the container to pass through the opening, and a second position in which the cover prevents the container from passing through the opening.

17. The vehicle of claim 14 which also includes a track extending along at least part of the path, and wherein a first portion of the track extends through the opening and the track includes a second portion that is received within the front compartment and which includes extends at a non-parallel angle to the first portion, and wherein the container is movable along the second portion to a position in which the container is not aligned with the first portion.

18. The vehicle of claim 17 wherein the container is a first container and wherein a second container is provided, the first container and the second container are both movable along the second portion and separately registrable with and movable along the first portion.
